(19) United States
(12) Patent Application Publication
(10) Pub. No.: US 2026/0233578 A1
(43) Pub. Date: Aug. 13, 2026

(54) HEATING SYSTEM OF A VEHICLE

(71) Applicant: MERCEDES-BENZ GROUP AG, Stuttgart (DE)

(72) Inventors: Valentin MAIER, Ispringen (DE); Benno STAMP, Stuttgart (DE)

(21) Appl. No.: 19/111,960

(22) PCT Filed: Jul. 24, 2023
(86) PCT No.: PCT/EP2023/070445

§ 371 Date: Mar. 14, 2025

(30) Foreign Application Priority Data
Sep. 16, 2022 (DE) 10 2022 003 419.0

(51) Int. Cl. B60H 1/00; B60H 1/22; B60N 2/56

(52) U.S. Cl. CPC B60H 1/00742; B60H 1/2226; B60H 1/2227; B60N 2/5678; B60H 2001/224

(57) ABSTRACT

A heating system of a vehicle includes panel heating elements arranged on objects in the vehicle for heating an interior of the vehicle by thermal radiation. A temperature control area is assigned to at least one vehicle seat of the vehicle and the panel heating element is assigned to a vehicle seat with a temperature control area. To determine the heating requirement of a vehicle occupant located on the vehicle seat with a temperature control area, corresponding sensor units are provided in the vehicle. A heating power of the at least one panel heating element assigned to a vehicle seat with a temperature control area is specified as a function of the heating requirement of the vehicle occupant.

### BACKGROUND AND SUMMARY OF THE INVENTION

Exemplary embodiments of the invention relate to a heating system of a vehicle.

To heat the interior of vehicles operated with internal combustion engines, the waste heat of the internal combustion engine is typically used for heating systems that control the temperature of the entire interior of the vehicle through convention. In particular, it is no longer possible to heat the interior in this way in electrically operated vehicles, meaning that alternative heating methods and heating systems have to be used here.

In particular, heating systems that control the temperature of the interior of the vehicle by radiant heat are also considered for these alternative heating methods. In these heating systems, heat is generated by thermal radiation (infrared radiation) in a targeted manner and locally at a specific point in the vehicle, i.e., heating the entire interior of the vehicle as in the case of heating by convection is no longer required.

On the topic of heating the interior of vehicles, a method for automatically setting a locally perceived temperature in a camping vehicle through radiant heat is disclosed in DE 10 2021 103 399 A1. In this known method, a plurality of electrical panel heaters are integrated into in each case a plurality of flat accessories at different usage areas in the interior of the camping vehicle. The heating power of at least one of these electrical panel heaters is regulated and/or controlled depending on the exact location of a person located in the interior of the camping vehicle. In particular, laminates, ceiling coverings or wall coverings, furniture, doors or similar objects are provided as flat accessories in the interior of the camping vehicle.

Systems and methods for radiating heat by PTC radiant panels are provided in U.S. Pat. No. 11,363,683 B2. A radiant heating system for heating an occupant of an enclosed space comprises panels for emitting heat into the enclosed space in the direction of the occupant. A power supply supplies electrical power to the panels. A control device controls the electrical power supplied to the panels based on a temperature in the enclosed space and the positions of the panels in the enclosed space.

DE 10 2014 210 962 A1 describes an air conditioning device for a motor vehicle, comprising a plurality of climate parameter influencing elements each assigned to a body area of a vehicle occupant, a plurality of sensors each assigned to a climate parameter influencing element, by means of which sensors a characteristic of the respectively assigned occupant body area can be determined, and a control device coupled to the sensors and to the climate parameter influencing elements, by means of which control device the climate parameter influencing elements can be controlled depending on the characteristic determined by means of the respectively assigned sensor. The invention is characterized in that the sensors are designed as distance sensors, and the characteristic determined by them is a distance between each sensor and the respectively assigned occupant body area.

DE 10 2019 202 223 A1 relates to an arrangement for heating a vehicle interior, in particular a rail vehicle interior, in which infrared surface radiant heaters are arranged in the interior to heat the vehicle interior. The infrared surface radiant heaters are designed as integrated components of surfaces of the interior.

Further relevant documents are also U.S. 2015/0028119 A1, DE 103 20 829 A1 and DE 10 2013 009 516 A1.

EP 2 578 423 B1 discloses a radiant heating device for a vehicle, comprising a radiant heater that emits radiant heat in the direction of a passenger and is provided together with an air conditioning system, which selectively introduces air outside a passenger compartment or air inside the passenger compartment and then supplies air-conditioned air created from the introduced air into the passenger compartment. The radiant heater contains a controller that varies the amount of radiant energy of the radiant heater depending on whether the air introduced into the air conditioning system is the air outside the passenger compartment or the injected air is the air in the passenger compartment. According to the radiant heating device, a warm feeling of comfort can be conveyed to the passenger both in the outside air intake mode and also in the inside air intake mode of the air conditioning system.

Based on this prior art, exemplary embodiments of the invention are directed to a generic heating system of a vehicle, with which the heating power can be adjusted conveniently and individually for a vehicle occupant in a simple manner.

With the heating system according to the invention, the interior of the vehicle is heated in a targeted manner by thermal radiation with at least one panel heating element, which is preferably arranged in an interior component of the vehicle, i.e., which is integrated in the interior component of the vehicle or is arranged on an interior component of the vehicle. In particular, at least one panel heating element is arranged in the vicinity of a vehicle seat, to which a specific temperature control area is assigned, i.e., a specific area surrounding the seat can be warmed or temperature-controlled with at least one panel heating element.

Here, any surface of an interior component of the vehicle can be provided as a receiving surface for a panel heating element, for example the backrest of a front seat of the vehicle and/or on the door covering of a side door of the vehicle and/or the footwell of the vehicle and/or the instrument panel of the vehicle and/or the center console of the vehicle and/or the headliner of the vehicle. Preferably, these receiving surfaces for a panel heating element are oriented in the direction of a respective vehicle occupant. For example, panel heating elements can be provided in the backrest part (seat back) of a front seat of the vehicle for the occupants in the rear of a vehicle.

For a vehicle occupant located on a vehicle seat with a temperature control area, their current heat requirement is determined and the heating power of the panel heating elements assigned to this vehicle seat is specified as a function thereof.

In an advantageous development of the invention, the heating power of the at least one panel heating element assigned to a vehicle seat with a temperature control area is specified by a control device of the vehicle, by which the voltage and current of the respective panel heating element is regulated and/or controlled according to the current heating requirement of the respective vehicle occupant located on a vehicle seat with a temperature control area.

A sensor unit preferably designed as an optical sensor unit or as a thermal sensor unit is provided in the vehicle for determining the current heating requirement of the vehicle occupant located on a vehicle seat with a temperature control area.

By means of a thermal imaging camera as a thermal sensor unit for determining the current heating requirement of the vehicle occupant located on a vehicle seat with a temperature control area, the surface temperature of illuminated body parts of the vehicle occupant located on a vehicle seat with a temperature control area be detected. Based on the respective surface temperature of the body parts of the vehicle occupant, the current heating requirement for the respective body part of the vehicle occupant can then be deduced and the heating power of at least one panel heating element assigned to this vehicle seat with a temperature control area can be controlled or regulated accordingly.

By means of an optical camera provided as an alternative to the thermal sensor unit or in addition to the thermal sensor unit as an optical imaging unit of an optical sensor unit for determining the current heating requirement of the vehicle occupant located on a vehicle seat with a temperature control area, the distance between at least one body part of the vehicle occupant located on this vehicle seat and the at least one panel heating element assigned to this vehicle seat can be detected and the current heating requirement of the vehicle occupant located on this vehicle seat can be derived from this and, in particular, the current heating requirement of different body parts of the vehicle occupant located on a vehicle seat with a temperature control area can also be derived. In particular, it can also be taken into account that the thermal energy absorbed by the vehicle occupant depends on the distance to the radiation source and thus on the distance to at least one panel heating element assigned to this vehicle seat with a temperature control area. As with the direct determination of the surface temperature of illuminated body parts of a vehicle occupant on the vehicle seat, it can also be taken into account here that different body parts of a vehicle occupant may have different heating requirements, for example there may be a significantly different heating requirement between the head area and the foot area of a vehicle occupant.

A capacitive sensor unit is provided to detect the distance between the at least one body part of the vehicle occupant and the at least one panel heating element. This capacitive sensor unit can be arranged in a panel heating element, i.e., integrated in the panel heating element and for this purpose be designed, for example, as a capacitive circuit in the panel heating element, or arranged on a panel heating element or arranged in the area between a panel heating element and a vehicle seat or integrated in a vehicle seat or arranged on a vehicle seat.

Alternatively, other sensor units utilizing measuring methods can also be provided for detecting the distance between the at least one part of the occupant's body and the at least one panel heating element, in particular also a combination of different sensor units of this type.

The positioning of a vehicle occupant located on a vehicle seat with a temperature control area can also be detected by using, according to the invention, an optical unit and in particular an optical camera. In particular, the seat position of the occupant and/or the posture of the occupant and/or the position of the limbs of the occupant and, optionally, other characteristic variables that have an influence on the heating requirement of an occupant can be detected by means of the optical sensor unit and, in particular, the optical camera, and the current heating requirement of the vehicle occupant located on a vehicle seat with a temperature control area can be derived from this. In other words, the current heating requirement of the vehicle occupant located on a vehicle seat with a temperature control area can also be derived in particular taking into account the current positioning of the vehicle occupant relative to the radiation surface of the at least one panel heating element assigned to this vehicle seat.

This also prevents, for example, a tall vehicle occupant sitting close to the panel heating elements due to their height from being too warm due to the then strong heating by the panel heating elements and a short vehicle occupant sitting further away from the panel heating elements due to their height from being too cold due to the then weak heating by the panel heating elements.

In a further advantageous development of the invention, certain physical characteristics or personal parameters of the occupant, such as in particular the height of the respective occupant and/or the clothing state of the respective occupant, can also be detected as further variables that have an influence on the heating requirement of a vehicle occupant located on a vehicle seat with a temperature control area, and the current heating requirement of the vehicle occupant located on a vehicle seat with a temperature control area can be derived from this.

For example, it can be assumed that the heating requirement in the leg area is lower for a vehicle occupant wearing shorts than for a vehicle occupant wearing long trousers or that the heating requirement is greater for a vehicle occupant wearing a jacket than for a vehicle occupant not wearing a jacket.

Advantageously, with the invention presented, a high level of thermal comfort for the vehicle occupants can be realized by taking into account different variables that have an influence on the current heating requirement of a vehicle occupant and the heating power of panel heating elements specified from this, thus creating a pleasant environment for the vehicle occupants.

Since the heating power is individually specified for the vehicle occupants and optimally for the respective application or the current boundary conditions in the interior of the vehicle, the interior of a vehicle can be heated very efficiently and in an energy-saving manner, preferably selectively, which is also highly relevant for the range of electrically powered vehicles in particular.

Further advantages, features and details of the invention can be seen from the following description of a preferred exemplary embodiment and with reference to the drawing with the two figures.

The features and combinations of features mentioned above in the description as well as the features and combinations of features mentioned below in the description of the figures and/or shown alone in the figures can be used not only in the combination indicated in each case, but also in other combinations or on their own, without leaving the scope of the invention.

### BRIEF DESCRIPTION OF THE DRAWING FIGURES

In the figures:

FIG. 1 shows a schematic illustration of the interior of a vehicle with a front seat of the vehicle and a vehicle occupant, and

FIG. 2 shows a further schematic illustration of the interior of a vehicle with a front seat of the vehicle and a vehicle occupant.

### DETAILED DESCRIPTION

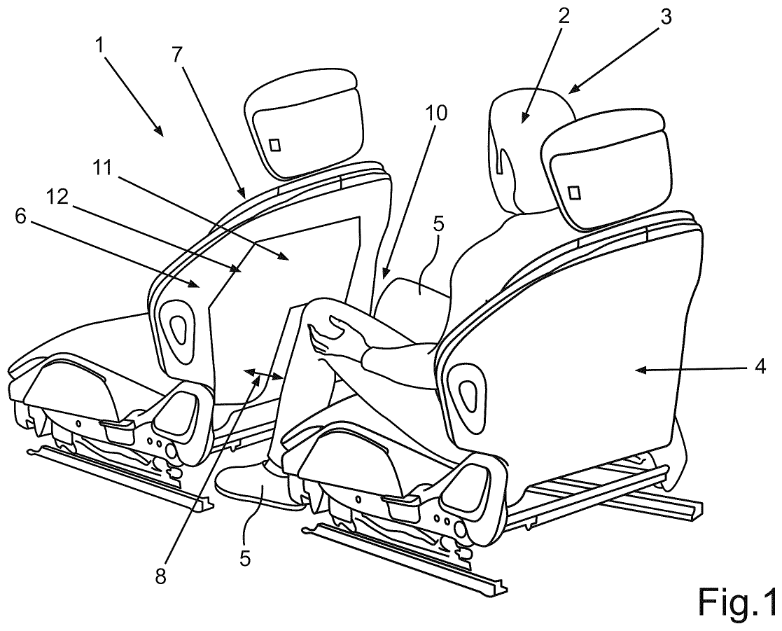

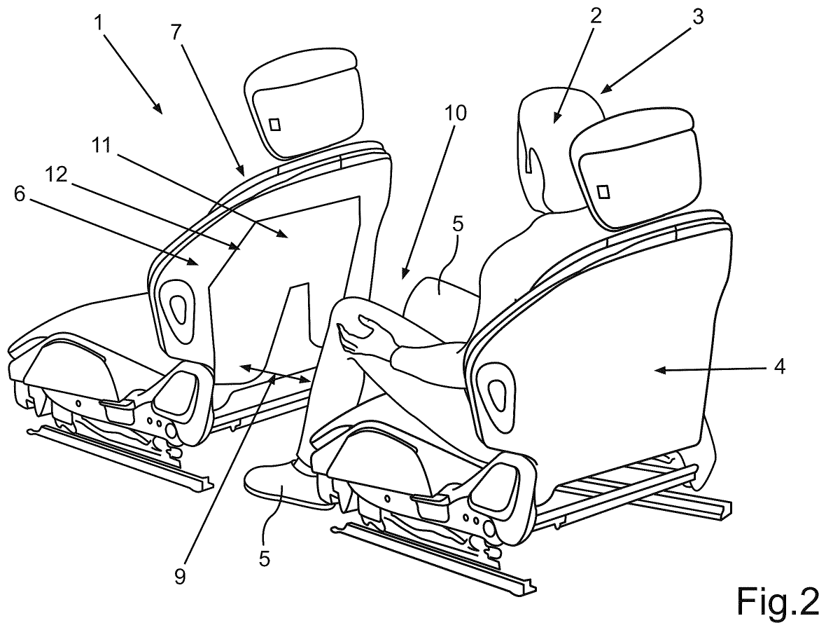

FIGS. 1 and 2 each show a schematic diagram of a partial region of the interior 1 of a vehicle with an occupant 2 located in the rear compartment 3 of the vehicle on a rear seat 4 of the vehicle.

The occupants 2 illustrated in the two figures on a rear seat 4 of the vehicle have different body sizes: the occupant 2 illustrated in FIG. 1 on a rear seat 4 of the vehicle is relatively tall, so that the legs 5 of the occupant 2 are located relatively close to the backrest 6 of a front seat 7 of the vehicle, i.e. at a short distance 8 to the backrest 6 of a front seat 5 of the vehicle; the occupant 2 illustrated in FIG. 2 on a rear seat 4 of the vehicle is relatively short in comparison, so that the legs 5 of the occupant 2 are also located relatively far away from the backrest 6 of a front seat 7 of the vehicle, i.e. at a greater distance 9 to the backrest 6 of a front seat 5 of the vehicle.

At specific positions in the interior 1 of the vehicle, panel heating elements 11 are arranged on interior components of the vehicle adjacent to the vehicle seats 4, 7 of the vehicle, the radiation surfaces of said panel heating elements are preferably oriented towards the respective vehicle seat 4, 7 of the vehicle.

To specify a temperature control area 10 for the rear seat 4 and thus to individually heat a specific region for the occupant 2 in the rear compartment 3 of the vehicle or for the occupant 2 located on the rear seat 4 of the vehicle, a panel heating element 11 is provided on the backrest 6 of the front seat 7 of the vehicle, which is integrated, for example, in the backrest tensioning part 12 in the backrest 6 of the front seat 5 of the vehicle.

To individually specify the heating power for the occupant 2 on a rear seat 4 of the vehicle, for example by a control device of the vehicle, the distance from the panel heating element 11 to specific parts of the body of the occupant 2 located on the rear seat 4 of the vehicle is determined, for example the distance 8, 9 from the panel heating element 11 to the legs 5 of the occupant 2 on a rear seat 4 of the vehicle, among other things. This determining of the distance 8, 9 from the panel heating element 11 to the legs 5 of the occupant 2 can be carried out, for example, by an optical camera which is arranged for example in the region of the vehicle roof, for example is integrated into the headliner of the vehicle, or which is arranged in the region of the center console of the vehicle.

As this distance 8 from the panel heating element 11 to the legs 5 of the occupant 2 is quite small in the case of a relatively tall occupant 2 (see FIG. 1), to heat the leg area of the occupant 2, the heating power of the panel heating element 11 that can be adjusted in a range of from 150 W up to 300 W can be specified with a low value, for example with a value of 180 W.

On the other hand, since this distance 9 from the panel heating element 11 to the legs 5 of the occupant 2 is quite large in the case of a relatively short occupant 2 (see FIG. 2), the heating power of the panel heating element 11 for heating the leg area of the occupant 2 should also be specified with a high value in this case, for example with a value of 250 W in the case of a heating power of the panel heating element 11 adjustable in a range from 150 W to 300 W.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

1-6. (canceled)

7. A heating system of a vehicle, the heating system comprising:
panel heating elements arranged on objects in the vehicle and configured to heat an interior of the vehicle by thermal radiation, wherein a temperature control area is assigned to at least one vehicle seat of the vehicle, wherein at least one of the panel heating elements is assigned to the vehicle seat with a temperature control area;
means for determining a heating requirement of a vehicle occupant located on the vehicle seat with the temperature control area;
a capacitive sensor unit configured to detect a distance between a body part of the vehicle occupant and the at least one of the panel heating elements assigned to the vehicle seat, wherein the capacitive sensor unit is integrated in the at least one of the panel heating elements assigned to the vehicle seat;
an optical sensor unit configured to determine a sitting position, a position of limbs, or posture of the vehicle occupant; and
means for specifying a heating power of the at least one of the panel heating elements assigned to the vehicle seat with the temperature control area as a function of the heating requirement of the vehicle occupant, the distance, and at least one of the sitting position, the position of the limbs, or the posture of the vehicle occupant.

8. The heating system of claim 7, further comprising:
an optical sensor unit configured to determine a height or a clothing state of the vehicle occupant, wherein the height or the clothing state of the vehicle occupant is accounted for in the determination of the heating requirement of the vehicle occupant located on the vehicle seat.

9. The heating system of claim 7, wherein the optical sensor unit has an optical camera as an optical imaging unit.

10. The heating system of claim 7, further comprising:
a thermal sensor unit configured as a heat imaging camera, which is configured to detect a surface temperature of body parts of the vehicle occupant located on the vehicle seat to determine the heating requirement of the vehicle occupant located on the vehicle seat with a temperature control area.

11. The heating system of claim 7, wherein the at least one of the panel heating elements is integrated into an interior component of the vehicle or is arranged on the interior component of the vehicle.

12. The heating system of claim 7, wherein the means for specifying the heating power is a control device of the vehicle.
